(19) United States
(12) Patent Application Publication
(10) Pub. No.: US 2019/0192375 A1
(43) Pub. Date: Jun. 27, 2019

(54) Portable Lower Leg Compression Device

(71) Applicant: Skender Sekiraqa, Lancaster, PA (US)

(72) Inventor: Skender Sekiraqa, Lancaster, PA (US)

(21) Appl. No.: 15/849,740

(22) Filed: Dec. 21, 2017

(51) Int. Cl. A61H 9/00

(52) U.S. Cl. CPC A61H 9/0078; A61H 2201/164; A61H 2209/00; A61H 2201/50; A61H 2201/165

(57) ABSTRACT

A portable lower leg compression device for applying pressure to a lower leg of a user includes a panel. Each of a plurality of bladders is coupled to an inner face of the panel and extends from adjacent to a first side to proximate to a second side of the panel. A plurality of first couplers is coupled to the panel proximate to the first side of the panel. A plurality of second couplers is coupled to the panel proximate to the second side of the panel. A compressor assembly is coupled to the panel and is operationally coupled to the plurality of bladders. Each second coupler is positioned to couple to a respective first coupler to couple the panel around the lower leg. The compressor assembly is positioned to selectively inject air into the bladders to inflate the bladders to apply pressure to the lower leg.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art Including Information Disclosed Under 37 CFR 1.97 and 1.98

The disclosure and prior art relates to compression devices and more particularly pertains to a new compression device for applying pressure to a lower leg of a user.

### BRIEF SUMMARY OF THE INVENTION

An embodiment of the disclosure meets the needs presented above by generally comprising a panel. Each of a plurality of bladders is coupled to an inner face of the panel and extends from adjacent to a first side to proximate to a second side of the panel. A plurality of first couplers is coupled to the panel proximate to the first side of the panel. A plurality of second couplers is coupled to the panel proximate to the second side of the panel. A compressor assembly is coupled to the panel and is operationally coupled to the plurality of bladders. Each second coupler is positioned to couple to a respective first coupler to couple the panel around the lower leg. The compressor assembly is positioned to selectively inject air into the bladders to inflate the bladders to apply pressure to the lower leg.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a portable lower leg compression device according to an embodiment of the disclosure.

FIG. 2 is a back view of an embodiment of the disclosure.

FIG. 3 is an in-use view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

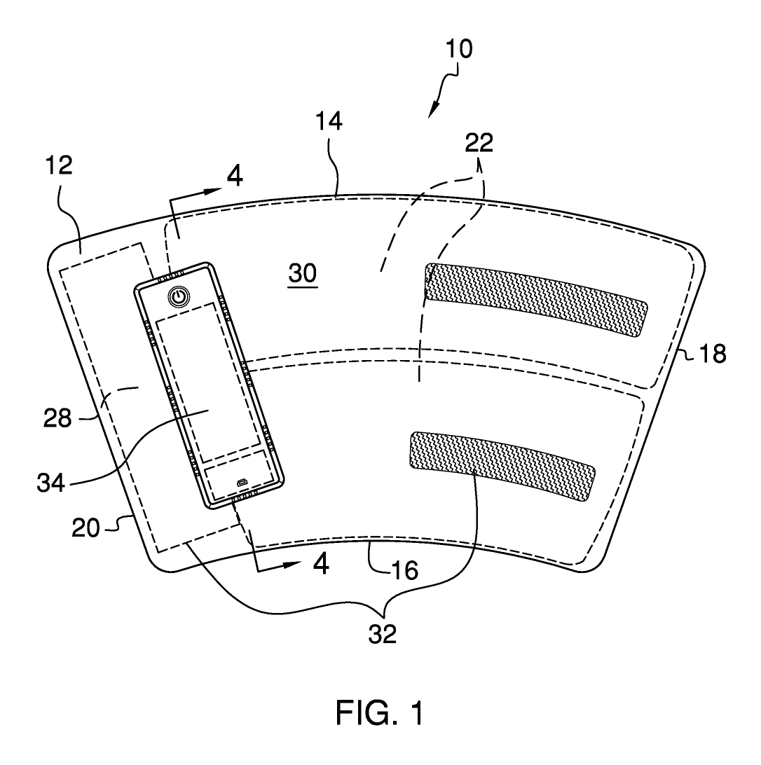

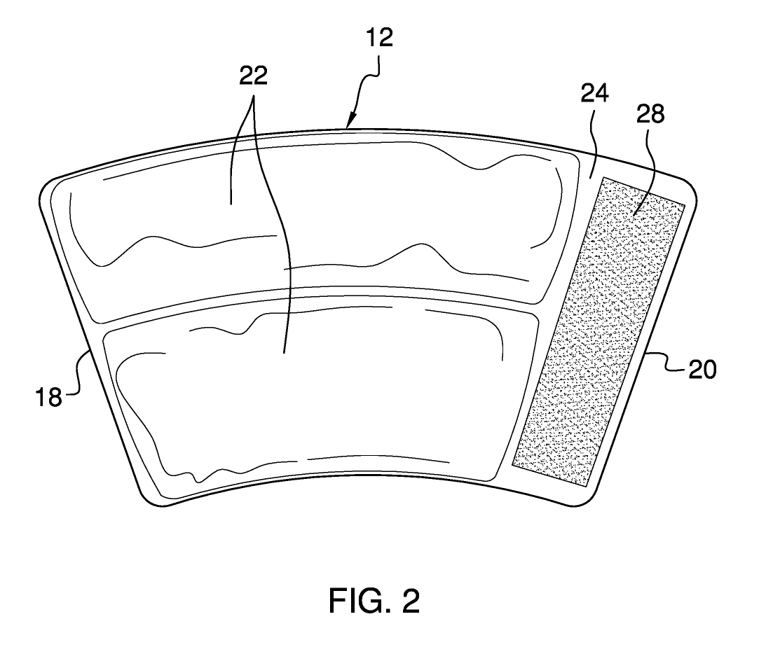

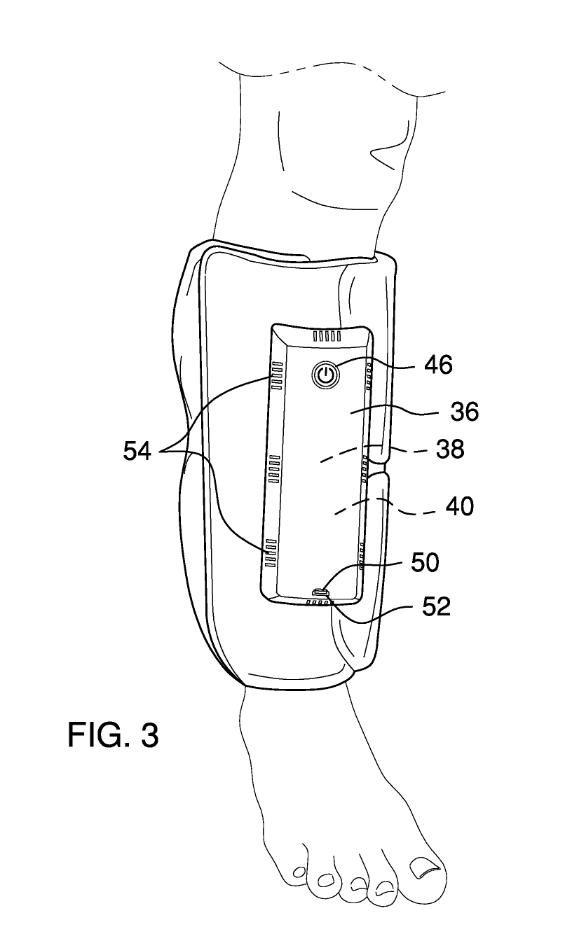

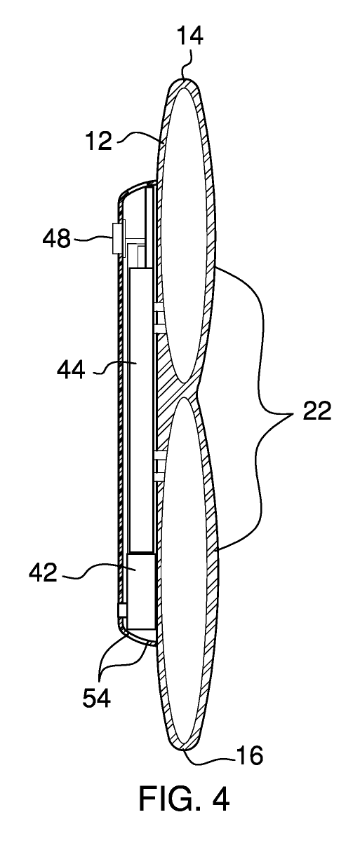

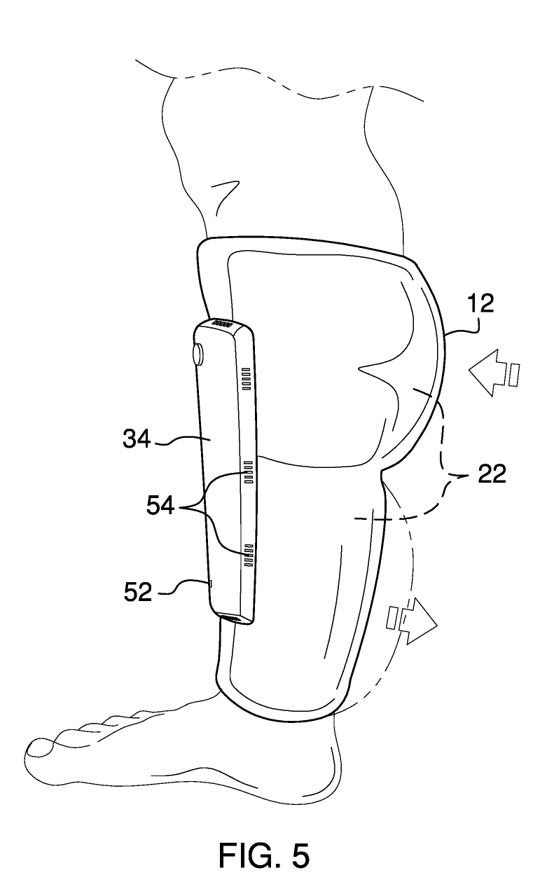

With reference now to the drawings, and in particular to FIGS. 1 through 5 thereof, a new compression device embodying the principles and concepts of an embodiment of the disclosure and generally designated by the reference numeral 10 will be described.

As best illustrated in FIGS. 1 through 5, the portable lower leg compression device 10 generally comprises a panel 12 that is configured to position around a lower leg of a user. In one embodiment, the panel 12 is sized to extend from proximate to an ankle to proximate to a knee of the leg. The panel 12 has a top 14 and a bottom 16. In another embodiment, the top 14 is dimensionally wider than the bottom 16 such that a first side 18 and a second side 20 of the panel 12 extend transversely between the top 14 and the bottom 16.

A plurality of bladders 22 is coupled to an inner face 24 of the panel 12. Each bladder 22 extends from adjacent to the first side 18 to proximate to the second side 20 of the panel 12. In one embodiment, the plurality of bladders 22 comprises from two to three bladders 22. In another embodiment, the plurality of bladders 22 comprises two bladders 22.

A plurality of first couplers 26 is coupled to the panel 12 proximate to the first side 18 of the panel 12. In one embodiment, each first coupler 26 is positioned on an outer face 30 of the panel 12 and extends toward the second side 20. A plurality of second couplers 28 is coupled to the panel 12 proximate to the second side 20 of the panel 12. The second couplers 28 are complementary to the first couplers 26. Each second coupler 28 is positioned to couple to a respective first coupler 26 to couple the panel 12 around the lower leg of the user. The bladders 22 are positioned between the panel 12 and the lower leg.

In one embodiment, the plurality of second couplers 28 comprises one second coupler 28 that is coupled to the inner face 24 of the panel 12. The second coupler 28 extends from proximate to the top 14 to proximate to the bottom 16 so that the second coupler 28 is positioned to couple to the plurality of first couplers 26. In another embodiment, each second coupler 28 and the respective first coupler 26 comprise a hook and loop fastener 32.

A compressor assembly 34 is coupled to the panel 12 proximate to the second side 20. The compressor assembly 34 is operationally coupled to the plurality of bladders 22. The compressor assembly 34 is positioned to selectively inject air into the bladders 22 to inflate the bladders 22. Pressure is applied to the lower leg to promote return of blood from the lower leg to a heart of the user and to decrease the likelihood of the user suffering a deep vein thrombosis. In one embodiment, the compressor assembly 34 is coupled to the outer face 30 of the panel 12 proximate to the second side 20.

The compressor assembly 34 comprises a housing 36 that defines an interior space 38. In one embodiment, the housing 36 is substantially rectangularly box shaped. A power module 40 and a pump 44 are coupled to the housing 36 and are positioned in the interior space 38. The pump 44 is operationally coupled to the power module 40. The pump 44 is positioned to selectively inject the air into the bladders 22 to inflate the bladders 22 to apply the pressure to the lower leg. In another embodiment, the power module 40 comprises at least one battery 42. In yet another embodiment, the at least one battery 42 is rechargeable.

A controller 46 is coupled to the housing 36. The controller 46 is operationally coupled to the power module 40 and the pump 44. The controller 46 is positioned to selectively couple the pump 44 to the power module 40 to inject the air into the bladders 22 to inflate the bladders 22 to apply the pressure to the lower leg. In one embodiment, the controller 46 comprises a button 48. The button 48 is depressible. The button 48 is configured to be depressed a first time to couple the pump 44 to the power module 40 to inject the air into the bladders 22 to inflate the bladders 22 to apply the pressure to the lower leg. The button 48 is configured to be depressed a second time to decouple the pump 44 from the power module 40 to release the air from the bladders 22 to deflate the bladders 22.

A connector 50 is coupled to the housing 36. The connector 50 is operationally coupled to the at least one battery 42. The connector 50 is configured to couple to a source of direct current to recharge the at least one battery 42. In one embodiment, the connector 50 comprises a micro-Universal Serial Bus port 52.

A plurality of apertures 54 is positioned through the housing 36. The apertures 54 are configured to vent the interior space 38.

In use, each second coupler 28 is positioned to couple to a respective first coupler 26 to couple the panel 12 around the lower leg of the user. The bladders 22 are positioned between the panel 12 and the lower leg. The button 48 is configured to be depressed the first time to couple the pump 44 to the power module 40 to inject the air into the bladders 22 to inflate the bladders 22. The pressure is applied to the lower leg to promote the return of the blood from the lower leg to the heart of the user and to decrease the likelihood of the user suffering the deep vein thrombosis. The button 48 is configured to be depressed the second time to decouple the pump 44 from the power module 40 to release the air from the bladders 22 to deflate the bladders 22. The apertures 54 are configured to vent the interior space 38. The micro-Universal Serial Bus port 52 is configured to couple to the source of direct current to recharge the at least one battery 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable lower leg compression device comprising:
a panel configured for positioning around a lower leg of a user;
a plurality of bladders coupled to an inner face of said panel, each said bladder extending from adjacent to a first side to proximate to a second side of said panel;
a plurality of first couplers coupled to said panel proximate to said first side of said panel;
a plurality of second couplers coupled to said panel proximate to said second side of said panel, said second couplers being complementary to said first couplers;
a compressor assembly coupled to said panel proximate to said second side, said compressor assembly being operationally coupled to said plurality of bladders; and
wherein said second couplers are positioned on said panel such that each said second coupler is positioned for coupling to a respective said first coupler for coupling said panel around the lower leg of the user positioning said bladders between said panel and the lower leg, wherein said compressor assembly is positioned on said panel such that said compressor assembly is positioned for selectively injecting air into said bladders for inflating said bladders for applying pressure to the lower leg.

2. The device of claim 1, further including said panel being sized to extend from proximate to an ankle to proximate to a knee of the leg.

3. The device of claim 2, further including said panel having a top and a bottom, said top being dimensionally wider than said bottom such that said first side and said second side of said panel extend transversely between said top and said bottom.

4. The device of claim 1, further including said plurality of bladders comprising from two to three said bladders.

5. The device of claim 4, further including said plurality of bladders comprising two said bladders.

6. The device of claim 1, further comprising:
said first couplers being positioned on an outer face of said panel, each said first coupler extending toward said second side; and
said plurality of second couplers comprising one said second coupler coupled to said inner face of said panel, said second coupler extending from proximate to said top to proximate to said bottom such that said second coupler is positioned for coupling to said plurality of first couplers.

7. The device of claim 1, further including each said second coupler and said respective said first coupler comprising a hook and loop fastener.

8. The device of claim 1, further including said compressor assembly being coupled to an outer face of said panel proximate to said second side.

9. The device of claim 8, further including said compressor assembly comprising:
a housing defining an interior space;
a power module coupled to said housing and positioned in said interior space;
a pump coupled to said housing and positioned in said interior space, said pump being operationally coupled to said power module; and
wherein said pump is positioned in said housing such that said pump is positioned for selectively injecting the air into said bladders for inflating said bladders for applying the pressure to the lower leg.

10. The device of claim 9, further including said housing being substantially rectangularly box shaped.

11. The device of claim 9, further including said power module comprising at least one battery.

12. The device of claim 11, further including said at least one battery being rechargeable.

13. The device of claim 9, further including a controller coupled to said housing, said controller being operationally coupled to said power module and said pump, wherein said controller is positioned on said housing such that said controller is positioned for selectively coupling said pump to said power module for injecting the air into said bladders for inflating said bladders for applying the pressure to the lower leg.

14. The device of claim 13, further including said controller comprising a button, said button being depressible, wherein said button is positioned on said housing such that said button is configured for depressing a first time for coupling said pump to said power module for injecting the air into said bladders for inflating said bladders for applying the pressure to the lower leg and wherein said button is configured for depressing a second time for decoupling said pump from said power module for releasing the air from said bladders for deflating said bladders.

15. The device of claim 12, further including a connector coupled to said housing, said connector being operationally coupled to said at least one battery, said connector being configured for coupling to a source of direct current for recharging said at least one battery.

16. The device of claim 15, further including said connector comprising a micro-Universal Serial Bus port.

17. The device of claim 9, further including a plurality of apertures positioned through said housing, wherein said apertures are positioned in said housing such that said apertures are configured for venting said interior space.

18. A portable lower leg compression device comprising:
a panel configured for positioning around a lower leg of a user, said panel being sized to extend from proximate to an ankle to proximate to a knee of the leg, said panel having a top and a bottom, said top being dimensionally wider than said bottom such that a first side and a second side of said panel extend transversely between said top and said bottom;
a plurality of bladders coupled to an inner face of said panel, each said bladder extending from adjacent to said first side to proximate to said second side of said panel, said plurality of bladders comprising from two to three said bladders, said plurality of bladders comprising two said bladders;
a plurality of first couplers coupled to said panel proximate to said first side of said panel, said first couplers being positioned on an outer face of said panel, each said first coupler extending toward said second side;
a plurality of second couplers coupled to said panel proximate to said second side of said panel, said second couplers being complementary to said first couplers, wherein said second couplers are positioned on said panel such that each said second coupler is positioned for coupling to a respective said first coupler for coupling said panel around the lower leg of the user positioning said bladders between said panel and the lower leg, said plurality of second couplers comprising one said second coupler coupled to said inner face of said panel, said second coupler extending from proximate to said top to proximate to said bottom such that said second coupler is positioned for coupling to said plurality of first couplers, each said second coupler and said respective said first coupler comprising a hook and loop fastener;
a compressor assembly coupled to said panel proximate to said second side, said compressor assembly being operationally coupled to said plurality of bladders, wherein said compressor assembly is positioned on said panel such that said compressor assembly is positioned for selectively injecting air into said bladders for inflating said bladders for applying pressure to the lower leg, said compressor assembly being coupled to said outer face of said panel proximate to said second side, said compressor assembly comprising:
a housing defining an interior space, said housing being substantially rectangularly box shaped,
a power module coupled to said housing and positioned in said interior space, said power module comprising at least one battery, said at least one battery being rechargeable,
a pump coupled to said housing and positioned in said interior space, said pump being operationally coupled to said power module, wherein said pump is positioned in said housing such that said pump is positioned for selectively injecting the air into said bladders for inflating said bladders for applying the pressure to the lower leg,
a controller coupled to said housing, said controller being operationally coupled to said power module and said pump, wherein said controller is positioned on said housing such that said controller is positioned for selectively coupling said pump to said power module for injecting the air into said bladders for inflating said bladders for applying the pressure to the lower leg, said controller comprising a button, said button being depressible, wherein said button is positioned on said housing such that said button is configured for depressing a first time for coupling said pump to said power module for injecting the air into said bladders for inflating said bladders for applying the pressure to the lower leg and wherein said button is configured for depressing a second time for decoupling said pump from said power module for releasing the air from said bladders for deflating said bladders,
a connector coupled to said housing, said connector being operationally coupled to said at least one battery, said connector being configured for coupling to a source of direct current for recharging said at least one battery, said connector comprising a micro-Universal Serial Bus port, and
a plurality of apertures positioned through said housing, wherein said apertures are positioned in said housing such that said apertures are positioned for venting said interior space; and
wherein said second couplers are positioned on said panel such that each said second coupler is positioned for coupling to a respective said first coupler for coupling said panel around the lower leg of the user positioning said bladders between said panel and the lower leg, wherein said button is positioned on said housing such that said button is configured for depressing the first time for coupling said pump to said power module for injecting the air into said bladders for inflating said bladders for applying the pressure to the lower leg and wherein said button is configured for depressing the second time for decoupling said pump from said power module for releasing the air from said bladders for deflating said bladders, wherein said apertures are positioned in said housing such that said apertures are configured for venting said interior space, wherein said micro-Universal Serial Bus port is positioned on said housing such that said micro-Universal Serial Bus port is configured for coupling to the source of direct current for recharging said at least one battery.
